(19) United States
(12) Patent Application Publication
(10) Pub. No.: US 2026/0034771 A1
(43) Pub. Date: Feb. 5, 2026

(54) SOFT POLYOLEFIN FILM AND FOAM LAMINATE FOR AIRBAG COVERS

(71) Applicant: Benecke-Kaliko AG, Hannover (DE)

(72) Inventors: Axel Eisengraeber-Pabst, Schorndorf (DE); Joshua Cram, Winchester, VA (US); David Andrade Morelos, Winchester, VA (US); Sai Ram Kumar Tummala, Göppingen (DE)

(73) Assignee: Benecke-Kaliko AG, Hannover (DE)

(21) Appl. No.: 18/790,120

(22) Filed: Jul. 31, 2024

(51) Int. Cl. B32B 25/04; B32B 1/00; B32B 25/14

(52) U.S. Cl. CPC B32B 25/045; B32B 1/00; B32B 25/14; B32B 2264/302; B32B 2264/303; B32B 2305/022; B32B 2307/536; B32B 2307/72; B32B 2605/08

(57) ABSTRACT

A soft, sewable polyolefin composition for vehicle interiors, particularly airbag covers, including, in weight percent based on total weight of the composition: (a) polypropylene random copolymer(s) present in a total amount of up to about 15 wt. %; (b) polypropylene homopolymer(s) present in a total amount from about 5 wt. % to about 20 wt. %; (c) thermoplastic vulcanizate(s) present in a total amount from about 25 wt. % to about 45 wt. %; and (d) present in a total amount from about 25 wt. % to about 50 wt. %: (d)(1) polyolefin elastomer(s), and/or (d)(2) olefin block copolymer(s) having elastomeric segments; optionally further including (e)(1) low density polyethylene(s) present in a total amount of up to about 25 wt. %, and/or (e)(2) mineral filler(s) present in a total amount of up to about 10 wt. %, with the combined total of (e)(1) and (e)(2), when present, being up to 25 wt. %.

### TECHNICAL FIELD

The present disclosure relates generally to a soft polyolefin cover material, which may be used in a composite structure, such as for airbag covers, and more particularly to a soft, sewable polyolefin film and foam laminate for airbag covers.

### BACKGROUND

Automotive interior materials designed for sewing with decorative or functional seams are utilized to convey a premium quality finish for vehicle interiors. These materials are typically composite laminate structures, often based on laminates made from polyvinylchloride (PVC) or polyurethane (PU) artificial leather. The sewable nature of these materials therefore allows for enhanced aesthetic appeal through detailed stitching at the seams. In addition, such materials can be used in the construction of airbag covers, providing airbag functionality without compromising on vehicle interior appearance.

For those areas of the vehicle interior that cover airbag openings, it is common to have the airbag cover with weakened areas on its underside to facilitate deployment of the airbag through the cover. These weakened areas are typically formed by processes such as cutting or laser scoring. A problem with these weakened areas, however, is that they are usually visible when used in the vehicle due to collapse of the layer(s) above the weakened area. Therefore, modern design trends demand that these areas are not visible to the consumer, and thus the current trend is to develop unweakened, or scoreless, airbag covers. These unweakened airbag covers have the additional benefit of reducing processing steps and cost to the customer.

### SUMMARY

Polyurethane or PVC artificial leather materials can be used for unweakened/scoreless airbag covers. However, although polyurethane or PVC artificial leather can be used in unweakened airbag covers, and can convey superior aesthetic feel and appearance that closely mimics real leather, these PVC or PU materials generally are more costly, weigh more, and are not as durable with resistance to cracking at high or low temperatures as compared to polyolefin materials.

Current polyolefin material technologies for unweakened airbag covers are based on foam laminates having a multi-layered thermoplastic polyolefin (TPO) cover layer that overlies and is bonded to the foam layer. These cover layers (also referred to as films, foils or skins) typically are hard, for example having a Shore A hardness of 80 or greater, and generally are not sewable. Accordingly, these hard, non-sewable coverings have the consumer perception of being plastic-like instead of leather-like, and therefore do not convey luxury and quality to the consumer. In addition, the multi-layered nature of TPO foam-film laminate coverings require specialized machinery and additional processing steps that add to their complexity and cost.

One or more aspects of the present disclosure solve one or more problems associated with conventional vehicle interior materials, and more particularly with conventional airbag covers.

According to an aspect, the present disclosure provides a polyolefin material that is soft and flexible, and which is suitable for use in vehicle interiors, including airbag covers.

According to an aspect, the polyolefin material has a Shore A hardness of less than 80, more particularly in a range from about 50 to about 70.

According to an aspect, the polyolefin material is sewable, exhibiting sufficient seam strength, stitch tear resistance and/or resistance to seam fatigue.

According to an aspect, the polyolefin material is extrudable and/or calenderable, therefore improving processability.

According to an aspect, the polyolefin material is suitable for vacuum forming and/or in-mold graining and/or shape lamination techniques such as press-laminating or using shaped blanks to form the composite structure.

According to an aspect, the polyolefin material forms at least one layer of a cover layer that overlies a foam layer in a composite structure. The composite may be a laminate structure in which the cover layer is operably bonded to the foam layer. Such a composite may be used as an airbag cover, more particularly an unweakened airbag cover.

According to an aspect, a single cover layer is provided as a compact monolayer formed from the polyolefin material and is not a multi-layered construction.

According to an aspect, the composite with the polyolefin (monolayer) cover provides clean and complete tears under dynamic testing conditions of airbag deployment or tests simulating airbag deployment.

According to an aspect, the composite with the polyolefin (monolayer) cover provides lower energy requirements to tear when tested under dynamic testing conditions.

According to an aspect, a polyolefin composition includes, in weight percent based on total weight of the composition: (a) one or more polypropylene random copolymer(s) (rPP) in a total amount from 0 wt. % to about 15 wt. %; (b) one or more polypropylene homopolymer(s) (hPP) present in a total amount from about 5 wt. % to about 40 wt. %; (c) one or more thermoplastic vulcanizate(s) (TPV) present in a total amount from about 15 wt. % to about 45 wt. %; (d) in a total amount from about 20 wt. % to about 50 wt. %, (d)(1) one or more polyolefin elastomer(s) (PoE) present, and/or (d)(2) one or more olefin block copolymer(s) (OBC).

According to an aspect, a composite includes: a substrate, and a cover layer overlying the substrate, wherein the cover layer includes a layer formed from a composition comprising, in weight percent based on total weight of the composition: (a) one or more random copolymer polypropylene(s) (rPP) present in a total amount of up to 15 wt. %; (b) one or more homopolymer polypropylene(s) (hPP) present in a total amount from 5 wt. % to 20 wt. %; (c) one or more thermoplastic vulcanizate(s) (TPV) present in a total amount from 25 wt. % to 45 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 50 wt. %; and optionally, (e)(1) one or more low density polyethylene(s) (LDPE) present in a total amount of up to 25 wt. %, and/or optionally (e)(2) one or more mineral filler(s) present in a total amount of up to 10 wt. %, wherein a combined total of (e)(1) and (e)(2), when both are present, is up to 25 wt. %.

According to aspect, a laminate airbag cover includes: a foam layer, and a single cover layer overlying and operably bonded to the foam layer, wherein the cover layer is a compact monolayer structure formed from a polyolefin composition comprising, in weight percent based on total weight of the composition: (a) one or more random copolymer polypropylene(s) (rPP) present in a total amount of up to 15 wt. %; (b) one or more homopolymer polypropylene(s) (hPP) present in a total amount from 5 wt. % to 20 wt. %; (c) one or more thermoplastic vulcanizate(s) (TPV) present in a total amount from 25 wt. % to 45 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 50 wt. %; and (e)(1) one or more low density polyethylene(s) (LDPE) present in a total amount of up to 25 wt. %, and/or (e)(2) one or more mineral filler(s) present in a total amount of up to 10 wt. %, wherein a combined total of (e)(1) and (e)(2), when both are present, is up to 25 wt. %; wherein the polyolefin layer is extrudable and/or calenderable and has a Shore A hardness according to ASTM D2240 in a range from 50 to 70.

The following description and the annexed drawings set forth certain illustrative embodiments according to the present disclosure. These embodiments are indicative, however, of but a few of the various ways in which the principles of the invention may be employed. Other objects, advantages and novel features according to aspects of the present disclosure will become apparent from the following detailed description when considered in conjunction with the drawings.

### BRIEF DESCRIPTION OF THE DRAWINGS

The annexed drawings, which are not necessarily to scale, show various embodiments according to the present disclosure.

FIG. 1 illustrates an exemplary composite structure which may be used for an airbag cover according to the present disclosure.

FIG. 2 illustrates an H-door airbag cover and its different modes of tearing.

FIG. 3 illustrates a U-door airbag cover and its different modes of tearing.

### DETAILED DESCRIPTION

The principles and aspects according to the present disclosure have particular application to airbag covers, such as for passenger vehicles, and thus will be described herein mainly in this context. It is understood, however, that the principles and aspects of the present disclosure may be applicable to other types of covers for other applications, or to the unique polyolefin material in general, when desirable to provide one or more advantages of the material(s) and/or construction(s) described herein.

At least some problems with current polyolefin material technologies for vehicle interiors, and for airbag covers in particular, is that such polyolefin materials are often very hard, for example having a Shore A hardness of 80 or greater. These materials also are usually not sewable. As such, these materials do not convey the perception of luxury. In addition, these polyolefin cover materials are usually formed from multiple different layers to achieve the desired functionality, which these multi-layered structures require specialized machinery and additional processing steps that add to their complexity and cost.

Aspect(s) according to the present disclosure provide a unique polyolefin composition and/or a unique composite construction using such a polyolefin composition that solves one or more problems in the art. More particularly, the unique polyolefin composition described herein includes a unique mixture of materials that provide one or more attributes of haptic softness, sewability, extrudability, calenderability, grainability, vacuum formability (e.g., positive or negative vacuum forming), shapability, tearability (e.g., isotropic tearing), suitable elasticity stringing, airbag deployability, etc. Such feature(s) may be provided in a single cover layer formed from a monolayer of the polyolefin material. These attributes will be described in further detail below.

Generally, the unique polyolefin composition according to the present disclosure may be used as a cover layer in vehicle interiors. The cover layer may be employed in a composite structure, in which the cover layer at least partially or wholly overlies a substrate. The composite may be a laminated composite in which the cover layer is operably bonded to the substrate with or without additional layer(s) bonded above and/or below the cover layer. With airbag covers, for example, the composite may be a so-called foam film laminate in which the cover layer is referred to as a film (or foil) which is operably bonded atop a foam layer as the substrate.

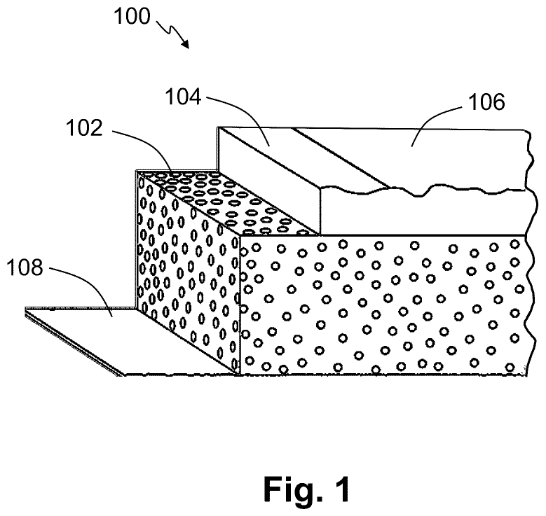

Referring to FIG. 1, a portion of an exemplary composite 100 in the form of a foam film laminate suitable for airbag covers is shown in perspective sectional view. As shown, the composite 100 (also referred to as foam-film laminate or laminate 100) includes a foam layer 102 and a cover layer 104 overlying and operably bonded to the foam layer 102. The composite 100 also may include a functional thin film lacquer layer 106 overlying the upper (outer) surface of the cover layer 104. The composite 100 may include a backing 108, which may serve as a primer or bonding layer for attaching the composite to a carrier in the airbag assembly. Additional bonding (primer) layers may be applied between layers, such as between the cover layer 104 and the foam layer 102, to suitably bond the layers together to form the laminate structure. Such bonding layers may utilize suitable adhesive material, for example.

In some embodiments, the cover layer 104 may be applied to the foam layer 102 via direct extrusion lamination or separate thermal lamination techniques. The cover layer 104 may be in direct engagement with the foam layer 102 to form a suitable bond without any additional bonding layer (e.g., adhesive). The cover layer 104 generally may be in a sheet form, such as a relatively thin film or foil when applied to the foam layer 102.

Any suitable process may be utilized to form the cover layer 104, such as extrusion techniques, which may use a single or twin-screw extruder, for example. These extrusion techniques may form the cover layer 104 in sheet form by shaping through a flat die.

In exemplary embodiments, the cover layer 104 may be formulated to permit calendaring of the polyolefin material, as described in further detail below. This may include the ability to be calendered using a 3, 4, or 5 calender roll setup in inverted-L, L, F, or Z configurations, for example. Such calenderability enables improved process control of the cover layer 104.

The cover layer 104 is the visible and haptic outer layer of the composite 100, and thus may include a decorative or ornamental design. For example, to mimic the texture and look of natural material, such as leather, the outer surface of the cover layer 104 may have a three-dimensionally structured surface in the form of graining. This graining may be applied via suitable techniques, such as in-mold graining during thermoforming, for example. This graining may be applied only to the cover layer 104 and is visible through the thin film lacquer layer 106 (if applied); or also may be included in the lacquer layer 106 in addition to the cover layer 104.

The size and shape of the composite 100 can vary greatly depending on the size and location of the airbag. For example, airbags can be employed in steering wheels, dashboards, doors, seats, and roof lining of the vehicle. Generally, the thickness of the composite 100 is not so great that it detrimentally impacts the deployment of the airbag. For example, the overall thickness of the composite 100 may be from about 1.0 mm to about 5.0 mm.

For airbag cover applications, the composite 100, including the cover layer 104, exhibits sufficient tear behavior to permit the airbag to deploy under dynamic conditions. Generally, to reduce energy losses and impairment of airbag deployment, the composite may be constructed so that all layers of the composite tear as simultaneously as possible. The elongation at break (according to ISO 1421) of the composite structure may be between about 200% to 750%. To enable such simultaneous deployment, each layer may have an elongation at break within this range (or subranges of values within this range).

To further facilitate simultaneous tear behavior and/or reduce energy loss, it also may be desirable that the bond strength between individual layers is so high that two layers cannot be separated without destroying one or both of the layers, for example as specified in ISO 2411. For example, the bond strength between the cover layer 104 and the foam layer 102 may be greater than the material strength of one or both layers, such that it is not possible to separate without the foam layer splitting.

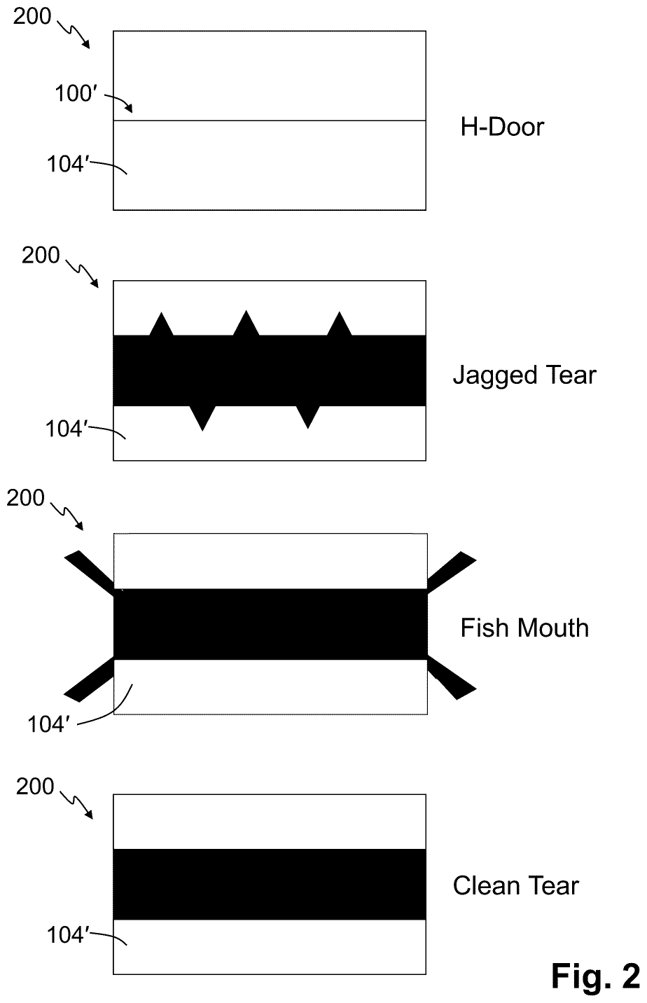

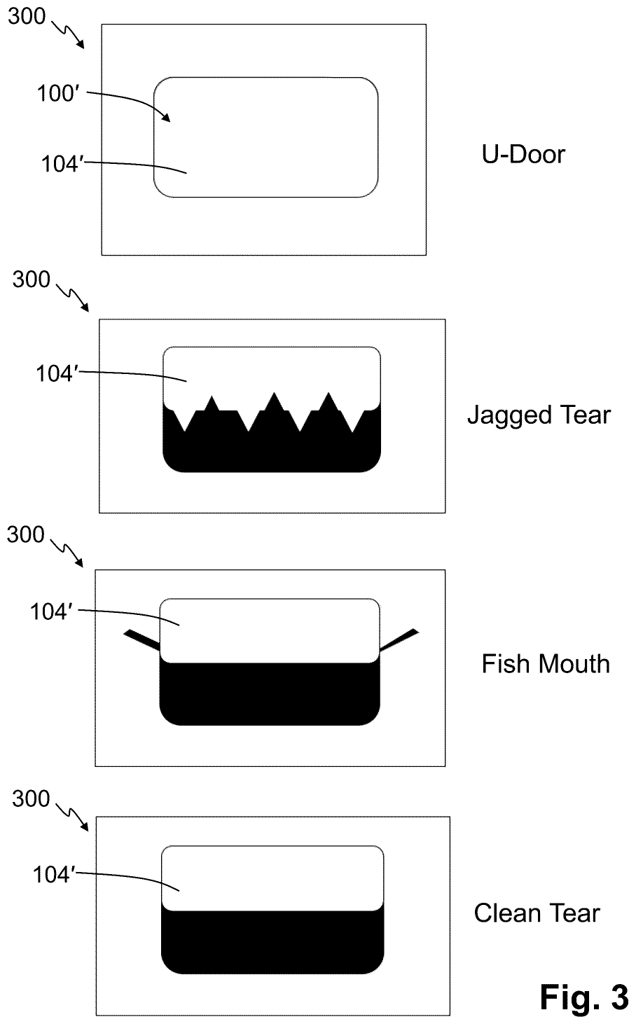

FIGS. 2 and 3 show examples of airbag covers 200, 300 that may employ a foam-film laminate material, as well as the resulting tear behavior that can occur in such material. FIG. 2 shows an exemplary H-door airbag cover construction and FIG. 3 shows an exemplary U-door airbag cover construction. As shown in these figures, if the composite 100′, including its cover layer 104′, are not constructed sufficiently, this can result in adverse tear behavior, including jagged tears or fish-mouth tears in which the tears do not follow the contours of the cover construction. It is beneficial, on the other hand, if the tear behavior results in clean tear where the demarcation of the tear closely follows the contour. The exemplary composite with cover layer according to the present disclosure can provide suitably clean tears in both H-door and U-door configurations, as will be described in further detail below.

In exemplary embodiments, the composite 100 of the airbag cover is unweakened. This means that the composite 100 does not have weakening structures imposed in the material, for example areas where material has been removed or thinned to form predetermined breaking lines or perforations. Examples of weakened structures include those that have been scored by physical cutting or laser scoring, which can result in material removal from the foam layer and cover layer. As such, these unweakened composites also are referred to as scoreless airbag covers. The exemplary composite with cover layer according to the present disclosure can provide suitable performance with an unweakened composite, as described below. This permits the exemplary airbag cover to be devoid of weakened areas that otherwise would be visible to the consumer such as due to collapse of material around these regions.

To provide a desired perception of being soft and luxurious akin to real leather, the overall composite 100, including foam layer 102 and cover layer 104, may have a Shore A hardness according to ASTM D2240 that is below 70, more particularly below about 65, such as in a range from about 30 to 70 Shore A. In exemplary embodiments, the Shore A hardness of the composite (foam-film laminate) is below 50, more particularly below about 45, such as in a range from about 35 to about 50. Such softness also permits the composite 100 to be sewable, which further conveys a perceived luxury and quality.

For suitability of sewing, the composite 100 may have suitable seam strength according to ISO 13935-1 and/or suitable stitch tear resistance according to ISO 23910. The composite 100 also may have suitable seam fatigue. As an example, the seam strength in the machine direction (MD) may be at least 120N, such as in a range from 120N to 500N; and the seam strength in the cross-machine direction (CMD) may be at least 90N, such as in a range from 90 to 400N, for example. The stitch tear-out resistance may be at least 40 N, for example.

The foam layer 102 may be formed from any suitable material with any suitable structure as desired for the application. Generally, the foam layer 102 should have sufficient strength for the airbag cover, but the strength should not be so high to impede airbag deployment. The foam layer 102 also is a major contributor to the vertical haptic softness of the composite 100 when depressed.

In exemplary embodiments, the foam may be a polyolefin foam, such as polypropylene (PP) foam. Such a PP foam may have at least 50 wt. % propylene monomer in the polymer, and may include other polyolefin monomers such as ethylene. The foam layer may include additional additives, such as stabilizers, fillers, lubricants, pigments, or the like, as may be conventional.

The foam layer may be an open-cell or closed-cell foam. The foam layer may be formed by foam extrusion using a blowing agent, such as a chemical blowing agent or an inert gas. The foam layer may have a density in a range from 40 to 200 kg/m³, more particularly from 67-125 kg/m³, or even more particularly about 100 kg/m³. The thickness of the foam layer may be from about 1 mm to about 4 mm, more particularly from about 1.5 mm to about 3.0 mm.

The lacquer layer 106 may be applied over the cover layer 104 and may be formed from materials such as resins, for example acrylic resin, polyurethane resin, or the like. The lacquer layer 106 may be relatively thin so as to not impede the cover layer 104 achieving its functions of softness, visual appeal, tearability, and the like. As an example, the lacquer layer 106 may have a thickness in a range from about 1 micrometer to about 30 micrometers.

As described above, the cover layer 104 is the layer that overlies the foam layer 102 and provide numerous functions such as haptic softness (particularly transverse haptic softness), sewability, grainability, visual appeal such as color, suitable tearability for airbag deployment, etc. As such, the cover layer 104 is the functional layer overlying the foam layer 102 which provides such properties, and thus ancillary or inconsequential layers not providing such functionality is not considered a cover layer. An example of this would be the lacquer layer 106 which is designed to not impair the cover layer performance. Another example may be a bonding layer between the cover layer and the foam layer, for example.

In exemplary embodiments, the cover layer 104 is soft and preferably has a leather-like softness as compared to a plastic-like feel. Accordingly, the cover layer 104 may have a Shore A hardness according to ASTM D2240 that is below 70, more particularly below 65, such as in a range from about 50 to 70 Shore A, for example in a range from about 55 to about 65 Shore A.

The cover layer 104 may have any suitable thickness and density, with thinner and less dense cover layers having less mass and thus being easier to tear with the energy of an airbag shot. In exemplary embodiments, the cover layer 104 may have an overall thickness in a range from about 0.2 mm to about 1.0 mm, more particularly from about 0.4 mm to about 0.8 mm. The cover layer 104 is compact meaning that it is not foamed. The density of the cover layer 104 may be in a range from about 0.85 g/cc to about 0.95 g/cc, more particularly about 0.9 g/cc. The selection of polymers and additives, if applicable, affect the density of the cover layer. For example, pigmentation for coloring may affect density slightly, with black pigments generally being less dense than lighter color pigments.

The cover layer 104 may have a monolayer or multilayer construction. In a multilayer construction, the cover layer 104 includes two or more sublayers that together form the overall cover layer. This combination of sublayers may thus constitute all compact (polyolefin) sublayers between the foam layer and lacquer layer (if applicable), or between a bonding layer (overlying the foam layer) and the lacquer layer (if applicable), assuming no ancillary or inconsequential layers are provided in between. These sublayers usually have different properties and work in conjunction with each other to provide the overall function of the cover layer.

In exemplary embodiments, the cover layer 104 according to the present disclosure is a monolayer construction so that a single layer forms the cover layer 104. In this manner, the single compact cover layer 104 with monolayer construction may constitute the entire thickness between the foam layer and lacquer layer (if applicable), or between a bonding layer (overlying the foam layer) and the lacquer layer (if applicable), assuming no ancillary or inconsequential layers are provided in between. Such a monolayer construction is advantageous in that it is less complex and requires less machinery and processing steps than multi-layer forms.

In an unexpected discovery, the present inventors found that the unique mixture of materials forming the polyolefin composition of the cover layer according to the present disclosure provides the aforementioned properties, including a soft, leather-like feel by having a hardness within the aforementioned Shore A hardness range(s) (e.g., 50-70 Sh. A), while also exhibiting good tearing behavior along the flap contour (e.g., isotropic tearing) and elasticity stringing suitable for airbag coverings. The exemplary polyolefin composition also exhibited good seam strength, demonstrating the ability for sewing and conveying the perception of luxury. Usually, such properties of isotropic tearing and seam strength are a tradeoff with softness, and so it was remarkable to achieve the combination of properties with the exemplary polyolefin composition. Moreover, this was accomplished with a single cover layer formed with a monolayer construction. This performance was demonstrated in both H-door and U-door airbag arrangements. Still further, the exemplary polyolefin composition was thermoformable (e.g., vacuum-formable), had good grain quality, and showed sufficient heat aging properties. The details of the exemplary polyolefin composition which forms the cover layer of the airbag cover will be further described hereinbelow according to aspect(s) and various embodiment(s) of the present disclosure.

According to an aspect of the disclosure, the polyolefin composition includes, in weight percent based on total weight of the composition: component (a) including one or more polypropylene random copolymer(s) (rPP) in a total amount from 0 wt. % to about 15 wt. %; component (b) including one or more polypropylene homopolymer(s) (hPP) present in a total amount from about 5 wt. % to about 40 wt. %; component (c) including one or more thermoplastic vulcanizate(s) (TPV) present in a total amount from about 15 wt. % to about 45 wt. %; and component (d) in a total amount from about 20 wt. % to about 50 wt. %, the component (d) including (d)(1) one or more polyolefin elastomer(s) (PoE) present, and/or (d)(2) one or more olefin block copolymer(s) (OBC).

In exemplary embodiment(s), the polyolefin composition more particularly includes, in weight percent based on total weight of the composition: component (a) including one or more polypropylene random copolymer(s) (rPP) present in a total amount of up to about 15 wt. %; component (b) including one or more polypropylene homopolymer(s) (hPP) present in a total amount from about 5 wt. % to about 20 wt. %; component (c) including one or more thermoplastic vulcanizate(s) (TPV) present in a total amount from about 25 wt. % to about 45 wt. %; and component (d) present in a total amount from about 25 wt. % to about 50 wt. %, the component (d) including (d)(1) one or more polyolefin elastomer(s) (PoE), and/or (d)(2) one or more olefin block copolymer(s) (OBC) having elastomeric segments.

In exemplary embodiment(s), the polyolefin composition may further include component (e) including (e)(1) one or more low density polyethylene(s) (LDPE) present in a total amount of up to about 25 wt. %.

Alternatively or additionally, in exemplary embodiment(s), the polyolefin composition may further include component (e)(2) one or more mineral filler(s) present in a total amount of up to about 10 wt. %. When both (e)(1) and (e)(2) are present, the combined total of (e)(1) and (e)(2) may be up to 25 wt. %.

The exemplary polyolefin composition may include additional additives, such as colorant(s)/pigment(s), stabilizer(s) (e.g., anti-degradants such as antioxidants and/or antiozonants, processing stabilizers for heat, etc.), and/or processing aid(s) (e.g., lubricants). As an example, the colorant(s) may be conventional, such as carbons for blacks, titania for whites, iron oxides for browns, and the like. The total amount of colorant(s) in the composition may depend on the desired final color, with darker colors generally containing less total colorant than lighter colors. Generally, the total amount of colorant(s) in the composition is up to about 15 wt. %. The stabilizer(s) may include materials such as phenolics, phosphates or the like for anti-degradant properties. The total amount of stabilizer(s) in the composition may be up to about 1 wt. % for example. The processing aid(s) may include lubricants such as stearic acid, oils or the like. The total amount of such processing aid(s) may be up to about 1 wt. %.

The term polyolefin composition or polyolefin-based composition as used herein is understood to mean that the total proportion of polyolefin(s) in the composition is 50 wt. % or greater. In exemplary embodiments, the polyolefin composition consists essentially of polyolefins (e.g., about 95 wt. % or 99% or more), or may consist entirely of polyolefins, not inclusive of the colorant(s) and/or stabilizer(s) and/or processing aid(s). The term weight percent in relation to a component of the composition is understood to mean weight percent of that component based on total weight (100%) of the component, unless otherwise stated. As used herein, the phrase “up to” a quantity of a component means that the quantity is present in the composition up to the specified amount, i.e., greater than zero up to the specified amount. A reference to a component being “optional” or reference to a range having a lower bound of zero weight percent (0 wt. %) means that the presence of the component in the composition is optional, i.e., the material is present in an amount or alternatively is not present in the composition.

Such ingredients of the exemplary polyolefin composition will be described in further detail below for sake of clarity and not limitation, it being understood that certain embodiments may provide different suitable combinations of these ingredient types and/or amounts, may include one or more additional ingredients or alternative equivalent ingredients in any suitable combination, or may eliminate one or more of these ingredients in any suitable combination, as would be understood by those having ordinary skill in the art in view of the teachings provided herein.

Component A: Polypropylene Random Copolymer(s) (rPP)

Polypropylene random copolymer (rPP) is a type of polypropylene copolymerized with fractions of ethylene or other alpha olefins. At least a majority of the rPP polymer constitutes PP, and the ethylene or other alpha olefins may be relatively small fraction, such as in a range from about 1 wt. % to about 10% wt. %. The alpha-olefin preferably has not more than 8 carbon atoms as the comonomer. The inclusion of ethylene or other alpha olefin units in the polymer chain introduces a random distribution, reducing the crystallinity of the material. This results in rPP having improved flexibility and impact resistance at lower temperatures compared to hPP.

One or more types of rPP may be contained in the polyolefin composition in a total amount from 0 wt. % to about 15 wt. %. In exemplary embodiments, the rPP is present in the polyolefin composition in a total amount up to 15 wt. %. In some embodiments, the rPP(s) are present in a total amount from about 10 wt. % to about 15 wt. %, more particularly about 5 wt. %.

The rPP(s) present in the polyolefin composition may have a melting range that is less than hPP and a greater melt flow rate than hPP due to the reduced crystallinity. For example, the rPP(s) may have a melting range with a maximum peak in the range of about 140° C. to 160° C., or not more than 150° C. The rPP(s) may have a density from about 0.85 g/cc to about 0.95 g/cc, more particularly about 0.90 g/cc. The melt flow rate (MFR) of the rPP(s) may be less than 40 g/10 min, more particularly up to about 20 g/10 min, for example up to about 15 g/10 min. The MFR (also referred to as melt flow index) is measured at a standard of 230° C. with a 2.16 kg mass.

Component B: Polypropylene Homopolymer(s) (hPP)

Polypropylene homopolymer (hPP) is a thermoplastic polymer synthesized by polymerizing propylene monomers. This results in a polymer chain having a major proportion of propylene units, for example consisting essentially of, or consists entirely of, propylene units. This structure generally leads to high crystallinity, providing properties such as rigidity and tensile strength, which may increase hardness of the composition.

One or more types of polypropylene homopolymer may be present in the polyolefin composition in a total amount from about 5 wt. % to about 40 wt. %. In exemplary embodiments, the hPP(s) are present in a total amount from about 5 wt. % to about 20 wt. %. In some embodiments, the hPP(s) are present in a total amount from about 10 wt. % to about 20 wt. %, more particularly from about 10 wt. % to about 15 wt. %.

The hPP(s) present in the polyolefin composition may have a melting range with a maximum peak in the range of about 150° C. to 170° C. The hPP(s) may have a density from about 0.85 g/cc to about 0.95 g/cc, more particularly about 0.90 g/cc. The melt flow rate (MFR) of the hPP(s) may be less than 40 g/10 min measured at 230° C. with a 2.16 kg mass, more particularly up to about 20 g/10 min, more particularly up to about 10 g/10 min, according to ISO 1133.

### Component C: Thermoplastic Vulcanizate(s) (TPV)

Thermoplastic vulcanizate (TPV) is a class of materials that combines the properties of thermoplastics and elastomers. TPVs are typically produced by having vulcanized elastomer(s) combined with thermoplastic polymer(s). This results in elastomeric (rubbery) phases dispersed within the more rigid thermoplastic matrix.

One or more types of TPV(s) may be contained in the polyolefin composition in a total amount from about 25 wt. % to about 45 wt. %. In exemplary embodiments, the TPV(s) are present in a total amount from about 25 wt. % to about 45 wt. %. In some embodiments, the TPV(s) are present in a total amount from about 25 wt. % to about 35 wt. %, such as about 30 wt. %. In other embodiments, the TPV(s) are present in a total amount from about 35 wt. % to about 45 wt. %, such as about 40 wt. %.

Generally, the TPV(s) are prepared either by mixing the thermoplastic with a particulate form of the vulcanized elastomer or via a process known as dynamic vulcanization. Dynamic vulcanization involves intimately mixing a blend of compatible polymers, then introducing a crosslinking system in the mixture while the mixing process is continued, whereby heat activates the crosslinking system to dynamically vulcanize the elastomer phase as it is dispersed within the thermoplastic phase.

The elastomer component in the TPV(s) may be up to about 70 wt. %, for example in a range from about 40 wt. % to about 60 wt. %. The particle size of the elastomer phase may be relatively fine, such as below about 10 μm, more particularly below about 1 μm, to provide a fine phase distribution. The relatively high fraction of elastomeric particles and their fine dispersion within the thermoplastic matrix can ensure that the TPV maintains its elastic properties even after multiple cycles of deformation.

The elastomer component in the TPV(s) may include olefin elastomer, such as ethylene propylene diene monomer (EPDM) rubber or ethylene propylene (EPR) rubber. Other types of rubber could be used alternatively or additionally, such as butyl rubber, nitrile rubber (NBR), styrene butadiene rubber, natural rubber, or the like. The thermoplastic component in the TPV(s) may include thermoplastic polyolefin, such as polypropylene (PP) and/or polyethylene (PE). Other types of thermoplastic may include polystyrene (PS), polyamide (PA), or the like.

In exemplary embodiments, the TPV(s) include EPDM or EPR and one or more of PP (e.g., hPP) and/or linear low-density polyethylene (LLDPE) (e.g., less than 0.93 g/cc). In EPDM, the content of ethylene units may be from about 45% to about 85% by weight, with the EPDM being more amorphous when the ethylene content is below about 55 wt. %. In EPR, the content of ethylene units may be from about 40% to about 80 wt %, more particularly 40 to 60 wt % by weight, in which the polymer becomes more crystalline when the ethylene content is greater than 60 wt %.

The TPV(s) also may be compounded with other additives, including one or more of reinforcing fillers (carbon black, mineral fillers), stabilizers, plasticizing oils, or the like. As an example, TPV(s) may contain up to 40 wt. % mineral oil and up to 10 wt. % talc. The balance of the composition may be the thermoplastic component(s) which may be a blend of thermoplastic polymers. Thus, for example, a TPV with 50 wt. % elastomer and 20 wt. % mineral oil may have about 30 wt. % thermoplastic, of which this may be divided among two or more thermoplastic polymers.

The density of TPV(s) may be in a range from about 0.85 g/cc to about 0.95 g/cc, more particularly about 0.90 g/cc or less. The hardness of the TPV(s) may be in a range from about 40 to 90 Shore A. The melting range with a maximum peak of the TPV(s) may be in a range from about 100-180° C., more particularly about 160-180° C. depending on the thermoplastic component. The melt flow rate (230° C., 10 kg) of the TPV(s) may be less than 40 g/10 min, more particularly up to about 20 g/10 min.

### Component D(1): Polyolefin Elastomer(s) (PoE)

The polyolefin composition may include one or more polyolefin elastomer(s) (PoE) in a total amount from about 20 wt. % to about 50 wt. %. In exemplary embodiments, the PoE(s) are present in a total amount from about 25 wt. % to about 50 wt. %. In some embodiments, the PoE(s) are present in a total amount from about 25 wt. % to about 35 wt. %, more particularly about 30 wt. %. In other embodiments, the PoE(s) are present in a total amount from about 30 wt. % to about 50 wt. %, more particularly about 40 wt. % to about 50 wt. %.

A polyolefin elastomer is a type of elastomer made from olefin monomers, more particularly with olefins having eight carbons or less. Examples of olefin monomers that form PoE may include ethylene, propylene, butene, hexene, or octene. In exemplary embodiments, the PoE may be selected from a combination of ethylene with α-olefin copolymer rubber (EAM) or ethylene with α-olefin/diene terpolymer rubber (EADM). These monomers may form PoEs such as ethylene-octene copolymers (EOC), ethylene-butene copolymers (EBC), ethylene-hexene copolymers (EHC), propylene-based elastomers (PBE), or the like.

In such PoEs, the ethylene may form the majority of the polymer backbone to impart crystallinity and strength, while the other alpha-olefins (such as butene, hexene or octene) may introduce branching that disrupts the crystallinity and imparts elastomeric properties to the material. As such, the polyolefin elastomers generally combine rubber-like elasticity with thermoplastic processability. They offer excellent low-temperature performance, flexibility, and good compatibility with other polyolefins.

The PoE(s) may be added into the polyolefin composition in an uncrosslinked state, whereby the PoE material will melt and flow to be intermixed with the other polymers to provide a uniform distribution of this material within the polyolefin composition. In exemplary embodiments, the PoE(s) remain uncrosslinked/unvulcanized in the polyolefin composition when forming the cover layer. As such, unlike synthetic rubbers like EPDM or EPR which are crosslinked/vulcanized with a vulcanizing agent, the PoE(s) introduced into the polyolefin composition may be designed to exhibit elastomeric properties without such crosslinking.

The hardness, melt flow rate, and melt range of the PoE(s) may vary depending on the particular grade. For example, the hardness of the PoE(s) may be in a range from about 40 Shore A to about 90 Shore A. The melt flow rate (190° C., 2.16 kg) may be less than 40 g/10 min, more particularly up to about 20 g/10 min, such as about 5-15 g/10 min. The melting range may have a maximum peak in a range from about 90° C. to about 140° C. The density of the PoE(s) may be in a range from about 0.85 to 0.95 g/cc, such as about 0.9 g/cc or lower.

### Component D(2): Olefin Block Copolymer(s) (OBC)

Alternatively or additionally to containing component d(1) polyolefin elastomer(s), the polyolefin composition may include one or more olefin block copolymer(s) (OBC). The OBC(s) may be present in a total amount from about 20 wt. % to about 50 wt. %. In exemplary embodiments, the OBC(s) are present in a total amount from about 25 wt. % to about 50 wt. %. In some embodiments, the OBC(s) are present in a total amount from about 25 wt. % to about 35 wt. %, more particularly about 30 wt. %. In other embodiments, the OBC(s) are present in a total amount from about 30 wt. % to about 50 wt. %, more particularly about 40 wt. % to about 50 wt. %.

The polyolefin composition may contain a combination of the component d(1) POE(s) and component d(2) OBC(s), in which case the total amount of both d(1) and d(2) would be in the aforementioned range(s), namely: 20 wt. % to about 50 wt. %, more particularly from about 25 wt. % to about 50 wt. %; more particularly from about 25 wt. % to about 35 wt. %; more particularly from about 30 wt. % to about 50 wt. %. In other words, if the composition contains 25 wt. % PoE(s) then the composition could contain up to 25 wt. % OBC(s) with the combined total being 50 wt. % of component D.

The olefin block copolymers (OBCs) are a class of polymers derived from the polymerization of olefin monomers. This may be primarily ethylene and alpha-olefins such as butene, hexene, or octene. These copolymers include alternating blocks of hard and soft segments, where the hard segments are crystalline (rigid) and the soft segments are amorphous (elastomeric). This unique structure imparts OBCs with a combination of strength, flexibility, and excellent elasticity.

The density of the OBC(s) may be in a range from about 0.85 to 0.95 g/cc (cubic centimeters), such as about 0.9 g/cc or lower. The melt flow rate (190° C., 2.16 kg) may be less than about 20 g/10 min, more particularly less than about 10 g/10 min, or even more particularly less than 5 g/10 min. The hardness may be in a range from about 40 to 90 Shore A, more particularly from about 50 to 80 Shore A. The melt range may have a maximum peak in a range from about 100° C. to about 140° C., for example.

### Component E(1): Low Density Polyethylene(s) (LDPE)

The polyolefin composition may include one or more low density polyethylene(s) (LDPE) in a total amount of up to 25 wt. %. In exemplary embodiments, the LDPE(s) are present in a total amount from about 15 wt. % to about 25 wt. %. In some embodiments, the LDPE(s) are present in a total amount of about 20 wt. %.

LDPE is produced by the polymerization of ethylene monomers. “Polyethylene (PE)” here means polymers or copolymers comprising a proportion of more than 50% by weight of ethylene. LDPE may contain a small amount of comonomer content, such as less than 1%. LDPE is known for its highly branched polymer structure, which results in a lower density and melting point. The density of LDPE may be from about 0.91 to about 0.94 g/cc, and may have a melting range with a maximum peak in a range from about 100° C. to about 120° C. LDPE has a high degree of short- and long-chain branching, which means that the chains do not form crystal structures and LDPE confers isotropic properties. This results in a lower tensile strength. The high degree of branching with long chains gives molten LDPE desirable flow properties, for example having a melt flow rate up to 10 g/10 min. LDPE may have weight-average molar mass Mw of from 20,000 to 500,000 g/mol, measured by GPC.

### Component E(2): Mineral Filler

Alternatively or additionally to containing component e(1) LDPE(s), the polyolefin composition may include one or more mineral filler(s). The mineral filler(s) may be present in a total amount up to about 10 wt. %. In exemplary embodiments, the mineral filler(s) are present in a total amount from about 1 wt. % to about 5 wt. %, more particularly about 2-3 wt. %.

The polyolefin composition may contain a combination of the component e(1) LDPE(s) and component e(2) mineral fillers(s), in which case the total amount of both d(1) and d(2) would be up to 25 wt. %, with (e)(2) mineral fillers being up to 10 wt. % and the (e)(1) LDPE being a balance. In other words, if the composition contains 10 wt. % mineral filler(s) then the composition could contain up to 15 wt. % LDPE(s) with the combined total being 25 wt. % of component E.

The mineral filler(s) could be any suitable mineral filler, such as kaolin/clay, calcium carbonate, talc, mica, wollastonite, or the like. In exemplary embodiments, the mineral filler may have a majority of silica content and may further include alumina and alkali oxides. The silica content may be less than 70 wt. % and the alkaline oxide content may be greater than 10 or 15 wt. %.

The mineral filler(s) may have any size and size distribution. In exemplary embodiments, the mineral filler has a mean particle size in the range from about 0.5 μm to about 5 μm, and is mixed within the polyolefin mixture to be uniformly distributed.

### EXAMPLES

Polyolefin compositions and corresponding foam-film laminates were prepared and tested for the purpose of further illustrating the nature of some of the embodiments and aspects of the present disclosure and are not intended as a limitation on the scope thereof. The test data for these evaluations are shown in Tables 1-15. In these tables, the amount of each component ingredient is shown in terms of weight percent.

The suitability for unweakened airbag applications was tested by means of a drop tower device to evaluate tear behavior, including isotropic tearability and elasticity stringing. H-flap and U-flap geometries were tested at an impact speed of approximately 10 m/s and evaluated based on tearing behavior. The test data shown is that of H-door geometry. This involved gluing a sample of the foam-film laminate to a thick plate featuring two flaps shaped like a typical H-door in an IP-application. The cover layer was a single cover layer having a monolayer construction and bonded to the foam layer. These doors were then opened by the drop tower impactor with a mass of approx. 15 kg with an approximate impact speed of 10-11 m/s. Samples were then graded according to their performance based on the closeness of the tear to the contour (isotropic tear behavior) and the degree of elasticity stringing. In some cases, comparative drop tower tests were carried out with a delivered energy of approximately 90-100 Joules (similar to that delivered during an airbag deployment) to validate this testing. In some cases, airbag deployments were also carried out to further validate drop tower results.

In the test data, Shore A testing was conducted according to ASTM D2240.

Evaluations for vacuum forming were conducted by heating the foam-film laminate to 140° C. and vacuum-forming on a small tool. Samples were evaluated in terms of grain quality, contour quality, and occurrence of defects (e.g. holes due to sharp corners).

To evaluate grainability, samples were grained heating the material to 180° C. and using a porous ceramic matrix having a negative image of the grain while applying a vacuum (principally an IMG process). The grain quality was evaluated in comparison to a master sample of the respective grain.

Heat aging was conducted according to ISO 188 method D, 21 d at 120° C.

Grain quality was evaluated in comparison to a master sample of the respective grain. Difference between the grades before and after heat aging was recorded.

Gloss was measured at 60° with a BYK micro-TRI-gloss device. Measurements were taken before and after heat aging and the difference was recorded.

Colour measurements were done with a standard colour measurement device at 8° geometry. Colour measurements were recorded before and after heat aging and the ΔE* was calculated from these measurements.

Torque rheometry was conducted using a torque rheometer and given a rating based on suitability; and mill stability was conducted on a two roll heated mill and also given a rating for suitability for calendaring.

Seam strength was evaluated according to ISO 13935-1. Stitch tear resistance was evaluated according to ISO 23910. Seam fatigue was evaluated by sewing the sample with a standard size needle and thread and a calibrated tension is applied, tension alternates sides of the connecting stitch. Change in the diameter of the stitch holes is measured. The final diameter of stitch holes under tension desirable are below a set value (typically 2 mm).

### Example Constructions 1 to 13

In a first series of experiments, the polyolefin mixtures were produced by premixing the ingredients and then extruding the mixture with a twin-screw extrude at approximately 200° C. to form a sheet. The sheet was laminated directly at the die with the foam to give a foam-film laminate. According to some microscopy results, this results in finely divided microstructure of the various different components of the composition intermixed together.

TABLE 1
Tear contour line quality/exact tearing along
flap contour (isotropic tearability)

| | rPP | hPP | TPV | PoE | LDPE | Test |
|---|---|---|---|---|---|---|
| Construction | (w/o) | (w/o) | (w/o) | (w/o) | (w/o) | result |
| 1 | 5 | 20 | 25 | 30 | 20 | 3.6 |
| 2 | 5 | 30 | 25 | 30 | 10 | 3.53 |
| 3 | 0 | 21 | 26 | 32 | 21 | 3.33 |
| 4 | 4 | 40 | 18.5 | 22.5 | 15 | 3.33 |
| 5 | 5 | 15 | 30 | 30 | 20 | 3.33 |
| 6 | 5 | 10 | 35 | 30 | 20 | 3.27 |
| 7 | 5 | 0 | 25 | 30 | 40 | 3 |
| 8 | 6 | 0 | 31 | 38 | 25 | 2.27 |
| 9 | 40 | 12.5 | 16 | 19 | 12.5 | 2.33 |
| 10 | 2.5 | 60 | 12.5 | 15 | 10 | 3.2 |
| 11 | 2 | 6.5 | 75 | 10 | 6.5 | 2.6 |
| 12 | 2 | 7 | 9 | 75 | 7 | 1.93 |
| 13 | 2.5 | 10 | 12.5 | 15 | 60 | 2.87 |

TABLE 2
Elasticity Stringing

| | rPP | hPP | TPV | PoE | LDPE | Test |
|---|---|---|---|---|---|---|
| Construction | (w/o) | (w/o) | (w/o) | (w/o) | (w/o) | result |
| 1 | 5 | 20 | 25 | 30 | 20 | 2 |
| 2 | 5 | 30 | 25 | 30 | 10 | 3 |
| 3 | 0 | 21 | 26 | 32 | 21 | 2 |
| 4 | 4 | 40 | 18.5 | 22.5 | 15 | 3 |
| 5 | 5 | 15 | 30 | 30 | 20 | 2 |
| 6 | 5 | 10 | 35 | 30 | 20 | 2 |
| 7 | 5 | 0 | 25 | 30 | 40 | 1 |
| 8 | 6 | 0 | 31 | 38 | 25 | 2 |
| 9 | 40 | 12.5 | 16 | 19 | 12.5 | 3 |
| 10 | 2.5 | 60 | 12.5 | 15 | 10 | 3.7 |
| 11 | 2 | 6.5 | 75 | 10 | 6.5 | 2.7 |
| 12 | 2 | 7 | 9 | 75 | 7 | 1.3 |
| 13 | 2.5 | 10 | 12.5 | 15 | 60 | 2 |

TABLE 3
Shore A Hardness of the Foam-film Laminate

| | rPP | hPP | TPV | PoE | LDPE | Test |
|---|---|---|---|---|---|---|
| Construction | (w/o) | (w/o) | (w/o) | (w/o) | (w/o) | result |
| 1 | 5 | 20 | 25 | 30 | 20 | 47 |
| 2 | 5 | 30 | 25 | 30 | 10 | 52 |
| 3 | 0 | 21 | 26 | 32 | 21 | 54 |
| 4 | 4 | 40 | 18.5 | 22.5 | 15 | 66 |
| 5 | 5 | 15 | 30 | 30 | 20 | 46 |
| 6 | 5 | 10 | 35 | 30 | 20 | 42 |
| 7 | 5 | 0 | 25 | 30 | 40 | 43 |
| 8 | 6 | 0 | 31 | 38 | 25 | 38 |
| 9 | 40 | 12.5 | 16 | 19 | 12.5 | 69 |
| 10 | 2.5 | 60 | 12.5 | 15 | 10 | 70 |
| 11 | 2 | 6.5 | 75 | 10 | 6.5 | 34 |
| 12 | 2 | 7 | 9 | 75 | 7 | 33 |
| 13 | 2.5 | 10 | 12.5 | 15 | 60 | 54 |

TABLE 4
Suitability for Vacuum-forming

| | rPP | hPP | TPV | PoE | LDPE | Test |
|---|---|---|---|---|---|---|
| Construction | (w/o) | (w/o) | w/o) | (w/o) | (w/o) | result |
| 1 | 5 | 20 | 25 | 30 | 20 | 7 |
| 2 | 5 | 30 | 25 | 30 | 10 | 5.5 |
| 3 | 0 | 21 | 26 | 32 | 21 | 7 |
| 4 | 4 | 40 | 18.5 | 22.5 | 15 | 6.5 |
| 5 | 5 | 15 | 30 | 30 | 20 | 7 |
| 6 | 5 | 10 | 35 | 30 | 20 | 7.5 |
| 7 | 5 | 0 | 25 | 30 | 40 | 7 |
| 8 | 6 | 0 | 31 | 38 | 25 | 7 |
| 9 | 40 | 12.5 | 16 | 19 | 12.5 | 5.5 |
| 10 | 2.5 | 60 | 12.5 | 15 | 10 | 6 |
| 11 | 2 | 6.5 | 75 | 10 | 6.5 | 7 |
| 12 | 2 | 7 | 9 | 75 | 7 | 8 |
| 13 | 2.5 | 10 | 12.5 | 15 | 60 | 8 |

TABLE 5
Grainability

| | rPP | hPP | TPV | PoE | LDPE | Test |
|---|---|---|---|---|---|---|
| Construction | (w/o) | (w/o) | (w/o) | (w/o) | (w/o) | result |
| 1 | 5 | 20 | 25 | 30 | 20 | 4 |
| 2 | 5 | 30 | 25 | 30 | 10 | 3.5 |
| 3 | 0 | 21 | 26 | 32 | 21 | 4 |
| 4 | 4 | 40 | 18.5 | 22.5 | 15 | 3.5 |
| 5 | 5 | 15 | 30 | 30 | 20 | 4 |
| 6 | 5 | 10 | 35 | 30 | 20 | 4 |
| 7 | 5 | 0 | 25 | 30 | 40 | 4 |
| 8 | 6 | 0 | 31 | 38 | 25 | 4 |
| 9 | 40 | 12.5 | 16 | 19 | 12.5 | 3.5 |
| 10 | 2.5 | 60 | 12.5 | 15 | 10 | 3 |
| 11 | 2 | 6.5 | 75 | 10 | 6.5 | 4 |
| 12 | 2 | 7 | 9 | 75 | 7 | 4 |
| 13 | 2.5 | 10 | 12.5 | 15 | 60 | 4 |

TABLE 6
Grain retention after heat aging

| | rPP | hPP | TPV | PoE | LDPE | Test |
|---|---|---|---|---|---|---|
| Construction | (w/o) | (w/o) | (w/o) | (w/o) | (w/o) | result |
| 1 | 5 | 20 | 25 | 30 | 20 | 0 |
| 2 | 5 | 30 | 25 | 30 | 10 | 0 |
| 3 | 0 | 21 | 26 | 32 | 21 | −0.25 |
| 4 | 4 | 40 | 18.5 | 22.5 | 15 | 0.25 |
| 5 | 5 | 15 | 30 | 30 | 20 | 0 |
| 6 | 5 | 10 | 35 | 30 | 20 | 0 |
| 7 | 5 | 0 | 25 | 30 | 40 | −0.25 |
| 8 | 6 | 0 | 31 | 38 | 25 | −0.5 |
| 9 | 40 | 12.5 | 16 | 19 | 12.5 | 0 |
| 10 | 2.5 | 60 | 12.5 | 15 | 10 | 0 |
| 11 | 2 | 6.5 | 75 | 10 | 6.5 | 0 |
| 12 | 2 | 7 | 9 | 75 | 7 | −2 |
| 13 | 2.5 | 10 | 12.5 | 15 | 60 | −2.5 |

TABLE 7
Gloss Change after Heat Aging

| | rPP | hPP | TPV | PoE | LDPE | Test |
|---|---|---|---|---|---|---|
| Construction | (w/o) | (w/o) | (w/o) | (w/o) | (w/o) | result |
| 1 | 5 | 20 | 25 | 30 | 20 | −0.1 |
| 2 | 5 | 30 | 25 | 30 | 10 | −0.1 |
| 3 | 0 | 21 | 26 | 32 | 21 | −0.1 |
| 4 | 4 | 40 | 18.5 | 22.5 | 15 | −0.1 |
| 5 | 5 | 15 | 30 | 30 | 20 | 0 |
| 6 | 5 | 10 | 35 | 30 | 20 | 0.1 |
| 7 | 5 | 0 | 25 | 30 | 40 | 1.1 |
| 8 | 6 | 0 | 31 | 38 | 25 | 1.2 |
| 9 | 40 | 12.5 | 16 | 19 | 12.5 | 0 |
| 10 | 2.5 | 60 | 12.5 | 15 | 10 | −0.1 |
| 11 | 2 | 6.5 | 75 | 10 | 6.5 | 0 |
| 12 | 2 | 7 | 9 | 75 | 7 | 1.1 |
| 13 | 2.5 | 10 | 12.5 | 15 | 60 | 4.2 |

TABLE 8
Color change Delta E* after heat aging

| | rPP | hPP | TPV | PoE | LDPE | Test |
|---|---|---|---|---|---|---|
| Construction | (w/o) | (w/o) | (w/o) | (w/o) | (w/o) | result |
| 1 | 5 | 20 | 25 | 30 | 20 | 0.2 |
| 2 | 5 | 30 | 25 | 30 | 10 | 0.1 |
| 3 | 0 | 21 | 26 | 32 | 21 | 0.1 |
| 4 | 4 | 40 | 18.5 | 22.5 | 15 | 0.1 |
| 5 | 5 | 15 | 30 | 30 | 20 | 0.5 |
| 6 | 5 | 10 | 35 | 30 | 20 | 0.8 |
| 7 | 5 | 0 | 25 | 30 | 40 | 5.1 |
| 8 | 6 | 0 | 31 | 38 | 25 | 4.9 |
| 9 | 40 | 12.5 | 16 | 19 | 12.5 | 0.1 |
| 10 | 2.5 | 60 | 12.5 | 15 | 10 | 0.4 |
| 11 | 2 | 6.5 | 75 | 10 | 6.5 | 0.2 |
| 12 | 2 | 7 | 9 | 75 | 7 | 4.4 |
| 13 | 2.5 | 10 | 12.5 | 15 | 60 | 0.8 |

TABLE 9
Seam Strength

| | | | | | | Test | Test |
|---|---|---|---|---|---|---|---|
| | rPP | hPP | TPV | PoE | LDPE | result | result |
| Construction | (w/o) | (w/o) | (w/o) | (w/o) | (w/o) | MD | CMD |
| 1 | 5 | 20 | 25 | 30 | 20 | 281 | 199 |
| 2 | 5 | 30 | 25 | 30 | 10 | 303 | 239 |
| 3 | 0 | 21 | 26 | 32 | 21 | 295 | 213 |
| 4 | 4 | 40 | 18.5 | 22.5 | 15 | 430 | 354 |
| 5 | 5 | 15 | 30 | 30 | 20 | 249 | 176 |
| 6 | 5 | 10 | 35 | 30 | 20 | 254 | 168 |
| 7 | 5 | 0 | 25 | 30 | 40 | 231 | 181 |
| 8 | 6 | 0 | 31 | 38 | 25 | 229 | 168 |
| 9 | 40 | 12.5 | 16 | 19 | 12.5 | 434 | 382 |
| 10 | 2.5 | 60 | 12.5 | 15 | 10 | n/a | n/a |
| 11 | 2 | 6.5 | 75 | 10 | 6.5 | 199 | 157 |
| 12 | 2 | 7 | 9 | 75 | 7 | 186 | 142 |
| 13 | 2.5 | 10 | 12.5 | 15 | 60 | 293 | 235 |

For isotropic tearability (Table 1), a test result above 3.0 indicates good suitability for nonscored airbag applications. For elasticity stringing (Table 2), a test result of min 2.0 indicates good suitability for nonscored airbag applications. For Shore A hardness of the overall composite (foam-film laminate) (Table 3), softness below 65 is good, below 70 acceptable. For vacuum-forming suitability (Table 4), test results above 7.0 are good, above 6.0 acceptable. For grainability (Table 5), test results above 3.5 are good. For grain retention after heat aging (Table 6), results with min −0.5 are good. For gloss change after heat aging (Table 7), results lower than 0.2 are good. For color change after heat aging (Table 8), results lower than 0.5 are good, lower than 1.0 acceptable. For seam strength (Table 9), results with min 120 N (MD) and min 90 N (CMD) are good.

In view of these results, it was determined that constructions #1, #5, and #6 were preferred constructions according to the present disclosure. It was found that deviation from these preferred constructions (1, 5 and 6) may lead to loss of certain properties. For example, it was found with respect to the rPP amount, an increase leads to loss of softness, grainability and vacuum forming performance getting worse; and a decrease does not show influence on product properties. With respect to the hPP amount, an increase leads to loss of softness, grainability and vacuum forming performance getting worse; and a decrease leads to loss of isotropic tear behavior (contour line quality) and low thermal stability (high gloss and colour change after heat aging). With respect to the TPV amount, an increase leads to reduction of isotropic tear behavior (contour line quality). With respect to LLDPE, an increase leads to reduction of isotropic tear behavior (contour line quality) and increased elasticity (stringing) as well as low thermal stability (worse grain retention, high gloss and colour change after heat aging). With respect to LDPE, an increase leads to reduction of isotropic tear behavior (contour line quality) and increased elasticity (stringing) as well as low thermal stability (worse grain retention, high gloss and colour change after heat aging).

According to these results, therefore, an exemplary polyolefin composition that can be used as a cover layer of an airbag cover, and more particularly a single cover layer in monolayer form, includes: (a) one or more random copolymer polypropylene(s) (rPP) present in a total amount from 5 wt. % to 10 wt. %; (b) one or more homopolymer polypropylene(s) (hPP) present in a total amount from 10 wt. % to 20 wt. %; (c) one or more thermoplastic vulcanizate(s) (TPV) present in a total amount from 25 wt. % to 35 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 35 wt. %; and (e)(1) one or more low density polyethylene(s) (LDPE) present in a total amount from 15 wt. % to 25 wt. %.

### Example Constructions 14 to 27

Following the first series of testing described above, it was found that that experimental construction 6 (mixture/formulation 6) from the first series of testing (above) did not have sufficient torque rheometry and mill stability suitable for calendering. Notably the torque rheometry criteria for construction 6 was rated as a fail and the mill stability was rated as a one (1). Thus, a second series of experiments (constructions/formulations 14 to 27), were conducted to modify the polyolefin composition so that the mixture could be calendered.

In the second series of experiments, the polyolefin mixtures were produced by mixing the ingredients at about 180° C. to about 200° C., whereby the ingredients were fused on a heated two roll mill. The produced film was then thermally laminated to a foam in a separate step to form the foam-film laminate structure.

TABLE 10
Exact Tearing along flap contour (isotropic tear behavior)

| | | | | | | Mineral | |
|---|---|---|---|---|---|---|---|
| | rPP | hPP | TPV | PoE | LDPE | Filler | Test |
| Construction | (w/o) | (w/o) | (w/o) | (w/o) | (w/o) | (w/o) | result |
| 14 | 5 | 20 | 40 | 25 | 10 | 2 | 2.6 |
| 15 | 5 | 40 | 20 | 25 | 10 | 2 | 1.6 |
| 16 | 5 | 0 | 60 | 25 | 10 | 2 | 3 |
| 17 | 0 | 20 | 40 | 25 | 15 | 2 | 2.8 |
| 18 | 10 | 20 | 40 | 25 | 5 | 2 | 2.4 |
| 19 | 5 | 20 | 43 | 12.5 | 10 | 2 | 2.8 |
| 20 | 5 | 20 | 28 | 37.5 | 10 | 2 | 3.2 |
| 21 | 0 | 20 | 45 | 25 | 10 | 2 | 3 |
| 22 | 10 | 20 | 35 | 25 | 10 | 2 | 2.6 |
| 23 | 5 | 20 | 40 | 35 | 0 | 2 | 3.4 |
| 24 | 5 | 20 | 40 | 15 | 20 | 2 | 3.2 |
| 25 | 5 | 10 | 40 | 45 | 0 | 2 | 3.6 |
| 26 | 5 | 10 | 40 | 45 | 0 | 5 | 3.6 |
| 27 | 5 | 10 | 40 | 45 | 0 | 10 | 3.8 |

In this second set of testing, for isotropic tear behavior (Table 10), a test result above 3.0 indicates good suitability for nonscored airbag applications. This data shows the following effects of each component:
Component A (rPP): Formulations 17 and 21, which have no rPP, exhibit reduced tearing. Conversely, Formulations 18 and 22, which are at the maximum range, also show reduced tearing behavior. The ideal tearing behavior is observed at approximately 5% content of rPP.
Component B (hPP): Formulation 15, which contains double the range of hPP, demonstrates reduced tearing behavior. Acceptable tearing behavior is observed at content levels of 20 or below.
Component C (TPV): Formulations 14-18, 21 and 22, which have TPV at the lower edge of the limit, show reduced tearing behavior. Formulation 19, which is below the range for TPV, also shows reduced tearing. Conversely, Formulation 16, with above-range content, shows a decrease in tearing behavior.
Component D (PoE): Formulations 14-19, 21 and 22, which have PoE content below the range, show reduced tearing behavior. In contrast, Formulations 20, 23, and 25-27, which are within range, show improved tearing, with the best results observed in Formulations 25-27, followed by 23 and then 20.
Component E (LDPE): A comparison between Formulations 14 and 24 shows that increasing the content of LDPE improves tearing.
Component F (Mineral Filler): The trend observed in Formulations 25-27 indicates that increasing the content of Mineral Filler improves tearing behavior.

TABLE 11
Elasticity Stringing

| | | | | | | Mineral | |
|---|---|---|---|---|---|---|---|
| | rPP | hPP | TPV | PoE | LDPE | Filler | Test |
| Construction | (w/o) | (w/o) | (w/o) | (w/o) | (w/o) | (w/o) | result |
| 14 | 5 | 20 | 40 | 25 | 10 | 2 | 4 |
| 15 | 5 | 40 | 20 | 25 | 10 | 2 | 4 |
| 16 | 5 | 0 | 60 | 25 | 10 | 2 | 3 |
| 17 | 0 | 20 | 40 | 25 | 15 | 2 | 3.5 |
| 18 | 10 | 20 | 40 | 25 | 5 | 2 | 3.5 |
| 19 | 5 | 20 | 43 | 12.5 | 10 | 2 | 4 |
| 20 | 5 | 20 | 28 | 37.5 | 10 | 2 | 3.5 |
| 21 | 0 | 20 | 45 | 25 | 10 | 2 | 3.5 |
| 22 | 10 | 20 | 35 | 25 | 10 | 2 | 4 |
| 23 | 5 | 20 | 40 | 35 | 0 | 2 | 3.5 |
| 24 | 5 | 20 | 40 | 15 | 20 | 2 | 4 |
| 25 | 5 | 10 | 40 | 45 | 0 | 2 | 3.5 |
| 26 | 5 | 10 | 40 | 45 | 0 | 5 | 3.5 |
| 27 | 5 | 10 | 40 | 45 | 0 | 10 | 3.5 |

For elasticity stringing (Table 11), a test result of min 2.0 indicates good suitability for nonscored airbag applications. This data shows the following effects of each component:
Component A (rPP): Comparisons between Formulations 17 vs 14 and 21 vs 19 show that increasing the content of rPP improves elasticity. The best results are obtained with formulations containing 5-10%.
Component B (hPP): Formulation 16, which lacks hPP, shows worsened results. Conversely, Formulation 15, with increased content, shows improved elasticity.
Component C (TPV): Formulations 14-15 show that reducing the content of TPV improves elasticity results, whereas Formulation 16, with increased content, shows worsened results.
Component D (PoE): Formulations 18-19 indicate that reducing the content of PoE improves elasticity, while Formulations 19-20 show that increasing content worsens elasticity.
Component E (LDPE): Formulations 23-24 demonstrate that increasing the content of LDPE improves elasticity, whereas Formulations 23-27 show that reducing the content worsens elasticity.
Component F (Mineral Filler): Formulations 25-27 show that increasing the content of Mineral Filler has little effect on elasticity.

TABLE 12
Shore A for Cover Layer

| | | | | | | Mineral | |
|---|---|---|---|---|---|---|---|
| | rPP | hPP | TPV | PoE | LDPE | Filler | Test |
| Construction | (w/o) | (w/o) | (w/o) | (w/o) | (w/o) | (w/o) | result |
| 14 | 5 | 20 | 40 | 25 | 10 | 2 | 80 |
| 15 | 5 | 40 | 20 | 25 | 10 | 2 | 85 |
| 16 | 5 | 0 | 60 | 25 | 10 | 2 | 65 |
| 17 | 0 | 20 | 40 | 25 | 15 | 2 | 76 |
| 18 | 10 | 20 | 40 | 25 | 5 | 2 | 81 |
| 19 | 5 | 20 | 43 | 12.5 | 10 | 2 | 76 |
| 20 | 5 | 20 | 28 | 37.5 | 10 | 2 | 71 |
| 21 | 0 | 20 | 45 | 25 | 10 | 2 | 68 |
| 22 | 10 | 20 | 35 | 25 | 10 | 2 | 78 |
| 23 | 5 | 20 | 40 | 35 | 0 | 2 | 65 |
| 24 | 5 | 20 | 40 | 15 | 20 | 2 | 76 |
| 25 | 5 | 10 | 40 | 45 | 0 | 2 | 60 |
| 26 | 5 | 10 | 40 | 45 | 0 | 5 | 60 |
| 27 | 5 | 10 | 40 | 45 | 0 | 10 | 62 |

For Shore A hardness of the cover layer (Table 12), softness below 65 is good, below 70 acceptable. This data shows the following effects of each component:
Component A (rPP): Comparisons between Formulations 17 vs 18 and 20 vs 21 indicate that increasing the content of rPP increases hardness, while reducing it lowers hardness.
Component B (hPP): Formulations 14 to 15 show that increasing the content of hPP increases hardness, while Formulations 23 vs 25 show that reducing it lowers hardness.
Component C (TPV): Comparisons between Formulations 20 vs 21 and 21 vs 22 indicate that increasing the content of TPV lowers hardness, while reducing it increases hardness.
Component D (PoE): Formulations 22 vs 23 and 23 vs 24 show that increasing the content of PoE lowers hardness, while reducing it increases hardness.
Component E (LDPE): Formulations 16 vs 17 and 22 vs 23 show that increasing the content of LDPE increases hardness, while reducing it lowers hardness.
Component F (Mineral Filler): Formulations 25-27 show that increasing the content of Mineral Filler increases hardness at the upper limit of the range.

TABLE 13
Shore A for Foam-Film Laminate

| | | | | | | Mineral | |
|---|---|---|---|---|---|---|---|
| | rPP | hPP | TPV | PoE | LDPE | Filler | Test |
| Construction | (w/o) | (w/o) | (w/o) | (w/o) | (w/o) | (w/o) | result |
| 14 | 5 | 20 | 40 | 25 | 10 | 2 | 50 |
| 15 | 5 | 40 | 20 | 25 | 10 | 2 | 55 |
| 16 | 5 | 0 | 60 | 25 | 10 | 2 | 48 |
| 17 | 0 | 20 | 40 | 25 | 15 | 2 | 48 |
| 18 | 10 | 20 | 40 | 25 | 5 | 2 | 55 |
| 19 | 5 | 20 | 43 | 12.5 | 10 | 2 | 51 |
| 20 | 5 | 20 | 28 | 37.5 | 10 | 2 | 50 |
| 21 | 0 | 20 | 45 | 25 | 10 | 2 | 46 |
| 22 | 10 | 20 | 35 | 25 | 10 | 2 | 48 |
| 23 | 5 | 20 | 40 | 35 | 0 | 2 | 45 |
| 24 | 5 | 20 | 40 | 15 | 20 | 2 | 48 |
| 25 | 5 | 10 | 40 | 45 | 0 | 2 | 38 |
| 26 | 5 | 10 | 40 | 45 | 0 | 5 | 38 |
| 27 | 5 | 10 | 40 | 45 | 0 | 10 | 40 |

For Shore A hardness of the overall foam-film laminate (Table 13), softness below 45 is good, below 50 acceptable. This data shows the following effects of each component:
Component A (rPP): Comparisons between Formulations 17 vs 18 and 20 vs 21 show that increasing the content of rPP increases hardness, while reducing it lowers hardness.
Component B (hPP): Formulations 14 to 15 and 2 vs 25 show that increasing the content of hPP increases hardness, while reducing it lowers hardness.
Component C (TPV): Comparisons between Formulations 20 vs 21 and 21 vs 22 indicate that increasing the content of TPV lowers hardness, while reducing it increases hardness.
Component D (PoE): Formulations 22 vs 23 and 23 vs 24 show that increasing the content of PoE lowers hardness, while reducing it increases hardness.
Component E (LDPE): The content of LDPE has little effect on composite hardness.

Component F (Mineral Filler): Formulations 25-27 show that increasing the content of Mineral Filler increases hardness at the upper limit of the range.

TABLE 14
Torque Rheometry

| | | | | | | Mineral | |
|---|---|---|---|---|---|---|---|
| | rPP | hPP | TPV | PoE | LDPE | Filler | Test |
| Construction | (w/o) | (w/o) | (w/o) | (w/o) | (w/o) | (w/o) | result |
| 6 | 5 | 10 | 35 | 30 | 20 | 0 | Fail |
| 14 | 5 | 20 | 40 | 25 | 10 | 2 | Fail |
| 15 | 5 | 40 | 20 | 25 | 10 | 2 | Pass |
| 16 | 5 | 0 | 60 | 25 | 10 | 2 | Fail |
| 17 | 0 | 20 | 40 | 25 | 15 | 2 | Fail |
| 18 | 10 | 20 | 40 | 25 | 5 | 2 | Pass |
| 19 | 5 | 20 | 43 | 12.5 | 10 | 2 | Fail |
| 20 | 5 | 20 | 28 | 37.5 | 10 | 2 | Pass |
| 21 | 0 | 20 | 45 | 25 | 10 | 2 | Fail |
| 22 | 10 | 20 | 35 | 25 | 10 | 2 | Pass |
| 23 | 5 | 20 | 40 | 35 | 0 | 2 | Pass |
| 24 | 5 | 20 | 40 | 15 | 20 | 2 | Pass |
| 25 | 5 | 10 | 40 | 45 | 0 | 2 | Pass |
| 26 | 5 | 10 | 40 | 45 | 0 | 5 | Pass |
| 27 | 5 | 10 | 40 | 45 | 0 | 10 | Pass |

For torque rheometry (Table 14), this was a pass fail test based on predetermined criteria. This data shows the following effects of each component:

### Formulation 6: Fails the Torque Rheometry Test.

Component A (rPP): The content of rPP has no effect on the test results.
Component B (hPP): Comparisons between Formulations 14 vs 15 show that increasing the content of hPP improves results.
Component C (TPV): Formulations 21 vs 22 show that reducing the content of TPV improves torque rheometry results.
Component D (PoE): The content of PoE has no effect on the test results.
Component E (LDPE): The content of LDPE has no effect on the test results.
Component F (Mineral Filler): The content of Mineral Filler has no effect on the test results.

TABLE 15
Mill Stability

| | | | | | | Mineral | |
|---|---|---|---|---|---|---|---|
| | rPP | hPP | TPV | PoE | LDPE | Filler | Test |
| Construction | (w/o) | (w/o) | (w/o) | (w/o) | (w/o) | (w/o) | result |
| 6 | 5 | 10 | 35 | 30 | 20 | 0 | 1 |
| 14 | 5 | 20 | 40 | 25 | 10 | 2 | 2 |
| 15 | 5 | 40 | 20 | 25 | 10 | 2 | 2 |
| 16 | 5 | 0 | 60 | 25 | 10 | 2 | 2 |
| 17 | 0 | 20 | 40 | 25 | 15 | 2 | 1 |
| 18 | 10 | 20 | 40 | 25 | 5 | 2 | 3 |
| 19 | 5 | 20 | 43 | 12.5 | 10 | 2 | 2 |
| 20 | 5 | 20 | 28 | 37.5 | 10 | 2 | 3 |
| 21 | 0 | 20 | 45 | 25 | 10 | 2 | 2 |
| 22 | 10 | 20 | 35 | 25 | 10 | 2 | 3 |
| 23 | 5 | 20 | 40 | 35 | 0 | 2 | 3 |
| 24 | 5 | 20 | 40 | 15 | 20 | 2 | 1 |
| 25 | 5 | 10 | 40 | 45 | 0 | 2 | 4 |
| 26 | 5 | 10 | 40 | 45 | 0 | 5 | 4 |
| 27 | 5 | 10 | 40 | 45 | 0 | 10 | 4 |

For mill stability (Table 15), this was rated between 0 (worst) to 4 (best), with a level of 4 making it suitable for calendaring. This data shows the following effects of each component:

### Formulation 6: Fails the Mill Stability Test.

Component A (rPP): The content of rPP has no effect on passing the Mill Stability test.
Component B (hPP): The content of hPP has no effect on passing the Mill Stability test.
Components C (TPV) and D (PoE): The interaction between TPV and PoE leads to passing the test. Formulation 24 shows that one level of TPV fails with PoE out of range. Formulation 25 shows that the same level of TPV passes when PoE is within range. Formulation 20 shows that PoE within range and TPV within range will also pass. All formulas where both TPV and PoE are within range pass, whereas when one or the other is not, it fails.
Component E (LDPE): The content of LDPE has no effect on Mill Stability.
Component F (Mineral Filler): Mineral Filler appears should be present to pass Mill Stability.

In view of these results, it was determined that constructions #25, #26 and #27 may be preferred constructions according to the present disclosure based on suitability for calendaring and satisfying other performance criteria. Construction #25 passed the criteria for vacuum-forming suitability, grainability, grain retention after heat aging, gloss change after heat aging, color change after heat aging, seam strength, stitch tear resistance and seam fatigue (described above for constructions 1-13); and constructions 26 and 27 also are expected to pass such criteria.

According to these results, therefore, an exemplary polyolefin composition that can be used as a cover layer of an airbag cover, and more particularly a single cover layer in monolayer form, and which is calenderable, includes: (a) one or more random copolymer polypropylene(s) (rPP) present in a total amount up to 15 wt. %; (b) one or more homopolymer polypropylene(s) (hPP) present in a total amount from 5 wt. % to 20 wt. %; (c) one or more thermoplastic vulcanizate(s) (TPV) present in a total amount from 25 wt. % to 45 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 30 wt. % to 50 wt. %; and (e)(2) one or more mineral filler(s) present in a total amount of up to 10 wt. %.

More particularly, the exemplary polyolefin composition which is calenderable may include (a) one or more random copolymer polypropylene(s) (rPP) present in a total amount from 5 wt. % to 10 wt. %; (b) one or more homopolymer polypropylene(s) (hPP) present in a total amount from 10 wt. % to 15 wt. %; (c) one or more thermoplastic vulcanizate(s) (TPV) present in a total amount from 35 wt. % to 45 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 40 wt. % to 50 wt. %; and (e)(2) one or more mineral filler(s) present in a total amount of up to 5 wt. %.

Exemplary polyolefin composition(s) and composite(s) such as for airbag cover(s) or other suitable coverings have been described herein.

According to aspect, a laminate airbag cover includes: a foam layer, and a single cover layer overlying and operably bonded to the foam layer, wherein the cover layer is a compact monolayer structure formed from a polyolefin composition comprising, in weight percent based on total weight of the composition: (a) one or more random copolymer polypropylene(s) (rPP) present in a total amount of up to 15 wt. %; (b) one or more homopolymer polypropylene(s) (hPP) present in a total amount from 5 wt. % to 20 wt. %; (c) one or more thermoplastic vulcanizate(s) (TPV) present in a total amount from 25 wt. % to 45 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 50 wt. %; and (e)(1) one or more low density polyethylene(s) (LDPE) present in a total amount of up to 25 wt. %, and/or (e)(2) one or more mineral filler(s) present in a total amount of up to 10 wt. %, wherein a combined total of (e)(1) and (e)(2), when both are present, is up to 25 wt. %; wherein the polyolefin layer is extrudable and/or calenderable and has a Shore A hardness according to ASTM D2240 in a range from 50 to 70.

Exemplary embodiment(s) may include one or more of the following additional features which may be combined separately or in any suitable combination with each other.

In exemplary embodiment(s), the laminate airbag cover is an unweakened airbag cover.

In exemplary embodiment(s), the laminate airbag cover is sewable.

In exemplary embodiment(s), the polyolefin composition comprises, in weight percent based on total weight of the composition: (a) one or more random copolymer polypropylene(s) (rPP) present in a total amount from 5 wt. % to 10 wt. %; (b) one or more homopolymer polypropylene(s) (hPP) present in a total amount from 10 wt. % to 20 wt. %; (c) one or more thermoplastic vulcanizate(s) (TPV) present in a total amount from 25 wt. % to 35 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 35 wt. %; and (e)(1) one or more low density polyethylene(s) (LDPE) present in a total amount from 15 wt. % to 25 wt. %.

In exemplary embodiment(s), the polyolefin composition comprises, in weight percent based on total weight of the composition: (a) one or more random copolymer polypropylene(s) (rPP) present in a total amount up to 15 wt. %; (b) one or more homopolymer polypropylene(s) (hPP) present in a total amount from 5 wt. % to 20 wt. %; (c) one or more thermoplastic vulcanizate(s) (TPV) present in a total amount from 25 wt. % to 45 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 30 wt. % to 50 wt. %; and (e)(2) one or more mineral filler(s) present in a total amount of up to 10 wt. %; wherein the polyolefin layer is calenderable.

In exemplary embodiment(s), the polyolefin composition comprises, in weight percent based on total weight of the composition: (a) one or more random copolymer polypropylene(s) (rPP) present in a total amount from 5 wt. % to 10 wt. %; (b) one or more homopolymer polypropylene(s) (hPP) present in a total amount from 10 wt. % to 15 wt. %; (c) one or more thermoplastic vulcanizate(s) (TPV) present in a total amount from 35 wt. % to 45 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 40 wt. % to 50 wt. %; and (e)(2) one or more mineral filler(s) present in a total amount of up to 5 wt. %; wherein the polyolefin layer is calenderable.

In exemplary embodiment(s), the polyolefin composition either: includes the (e)(1) LDPE(s) and does not include the (e)(2) mineral filler(s); or includes the (e)(2) mineral filler(s) and does not include the (e)(1) LDPE(s).

In exemplary embodiment(s), the polyolefin composition either: includes the (d)(1) PoE(s) and does not include the (d)(2) OBC(s); or includes the (d)(2) OBC(s) and does not include the (d)(1) PoE(s).

In exemplary embodiment(s), proportions of components (a), (b), (c), (d)(1) and/or d(2), (e)(1) and/or (e)(2) in combination total at least 95 wt. % of the composition, more particularly at least 99 wt. %, more particularly 100 wt. % of the composition, not inclusive of colorants and/or stabilizers and/or processing aids.

In exemplary embodiment(s), a density of the polyolefin composition is in a range from 0.85 g/cc to 0.95 g/cc.

In exemplary embodiment(s), the TPV(s) include ethylene propylene diene monomer (EPDM) rubber as an elastomer phase and polypropylene (PP) as a thermoplastic phase.

In exemplary embodiment(s), the PoE(s) are not crosslinked.

In exemplary embodiment(s), the PoE(s) are selected from ethylene-octene copolymers (EOC), ethylene-butene copolymers (EBC), and/or ethylene-hexene copolymers (EHC).

In exemplary embodiment(s), the mineral filler(s) have a particle size in a range from 0.5 μm to 5 μm.

In exemplary embodiment(s), the foam layer has a density in a range from 40 to 200 kg/m³.

In exemplary embodiment(s), the Shore A hardness of the laminate is in a range from 30 to 70 according to ASTM D2240.

According to another aspect, a composite includes: a substrate, and a cover layer overlying the substrate, wherein the cover layer includes a layer formed from a composition comprising, in weight percent based on total weight of the composition: (a) one or more random copolymer polypropylene(s) (rPP) present in a total amount of up to 15 wt. %; (b) one or more homopolymer polypropylene(s) (hPP) present in a total amount from 5 wt. % to 20 wt. %; (c) one or more thermoplastic vulcanizate(s) (TPV) present in a total amount from 25 wt. % to 45 wt. %; (d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 50 wt. %; and optionally, (e)(1) one or more low density polyethylene(s) (LDPE) present in a total amount of up to 25 wt. %, and/or optionally (e)(2) one or more mineral filler(s) present in a total amount of up to 10 wt. %, wherein a combined total of (e)(1) and (e)(2), when both are present, is up to 25 wt. %.

Exemplary embodiment(s) may include one or more of the foregoing additional features and/or the following additional features, which may be combined separately or in any suitable combination with each other.

For example, in exemplary embodiment(s), the substrate of the composite is a plastic such as PC/ABS or PP or EPDM.

In exemplary embodiment(s), the composite is used as a vehicle interior component other than an airbag cover, such as an interior trim component or seat component.

According to another aspect, a polyolefin composition includes, in weight percent based on total weight of the composition: (a) one or more polypropylene random copolymer(s) (rPP) in a total amount from 0 wt. % to about 15 wt. %; (b) one or more polypropylene homopolymer(s) (hPP) present in a total amount from about 5 wt. % to about 40 wt. %; (c) one or more thermoplastic vulcanizate(s) (TPV) present in a total amount from about 15 wt. % to about 45 wt. %; (d) in a total amount from about 20 wt. % to about 50 wt. %, (d)(1) one or more polyolefin elastomer(s) (PoE) present, and/or (d)(2) one or more olefin block copolymer(s) (OBC).

Exemplary embodiment(s) may include one or more of the foregoing additional features and/or the following additional features, which may be combined separately or in any suitable combination with each other.

In exemplary embodiment(s), the component (a) is present in a total amount up to 15 wt. %; more particularly in a total amount from 5 wt. % to 10 wt. %.

In exemplary embodiment(s), the component (b) is present in a total amount from 5 wt. % to 20 wt. %, more particularly in a total amount from 10 wt. % to 20 wt. %; more particularly in a total amount from 10 wt. % to 15 wt. %.

In exemplary embodiment(s), the component (c) is present in a total amount from 25 wt. % to 45 wt. %, more particularly in a total amount from 25 wt. % to 35 wt. % or in a total amount from 35 wt. % to 45 wt. %.

In exemplary embodiment(s), the component (d) is present in a total amount from 30 wt. % to 50 wt. %, more particularly in a total amount from 25 wt. % to 35 wt. % or in a total amount from 40 wt. % to 50 wt. %.

In exemplary embodiment(s), the component (e) is (e)(1) and is present in a total amount from 15 wt. % to 25 wt. %.

In exemplary embodiment(s), the component (e) is (e)(2) and is present in a total amount of up to 10 wt. %; more particularly in a total amount of up to 5 wt. %.

In exemplary embodiment(s), the polyolefin composition is incorporated into an interior part of a motor vehicle.

In exemplary embodiment(s), the polyolefin composition is incorporated into a dashboard, a trim part, and/or a seat.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. Thus, while a particular feature may have been described with respect to only one or more of several embodiments, such feature may be combined with one or more other features of the other embodiments, separately or in any combination. The same may also be varied in many ways. Such variations are not to be regarded as a departure from the disclosure, and all such modifications are intended to be included within the scope of the disclosure. as may be desired and advantageous for any given or particular application.

Any background information contained in this disclosure is to facilitate a better understanding of the various aspects described herein. It should be understood that any such background statements are to be read in this light, and not as admissions of prior art. Likewise, the description and examples are presented herein solely for the purpose of illustrating the various embodiments of the disclosure and should not be construed as a limitation to the scope and applicability of the disclosure.

The phrase “and/or” as used in this disclosure should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The phrase “at least one of [A], [B] and [C]” and the phrase “one or more of [A], [B] and [C]” are synonymous with the phrase “and/or” and are used to mean “one, or more, or all.” Thus, as a non-limiting example, this could mean (1) A only, (2) B only, (3) C only, (4) A and B, (5) A and C, (6) B and C, or (7) all of A, B and C.

The word “or” as used in this disclosure should be understood as being inclusive and not exclusive. For example, when separating items in a list, “or” or “and/or” shall be interpreted as being inclusive, i.e., the inclusion of at least one, but also including more than one, of a number or list of elements, and, optionally, additional unlisted items. For example, a condition A or B is satisfied by anyone of the following: A is true (or present) and B is false (or not present), A is false (or not present) and B is true (or present), and both A and B are true (or present). Only terms clearly indicating exclusivity should be interpreted as indicating exclusive alternatives (i.e. “one or the other but not both”), such as “either,” “only one of,” or “exactly one of.” In other words, such terms of exclusivity refer to the inclusion of exactly one element of a number or list of elements.

Any references to “one embodiment” or “an embodiment” as used herein is understood to mean that a particular element, feature, structure, or characteristic described in connection with the embodiment is included in at least one embodiment. The appearances of the phrase “in one embodiment” in various places in the specification are not necessarily referring to the same embodiment.

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The word “exemplary” is used herein to mean “serving as an example or illustration.” Any aspect or design described herein as “exemplary” is not necessarily to be construed as preferred or advantageous over other aspects or designs. Likewise, the phrases “particularly,” “preferably,” or the like as used in this disclosure may refer to an element or value that provides advantage(s) in some embodiment(s), however is not intended to limit the scope of the disclosure to those “particular” or “preferable” features.

Transitional language such as “including,” “comprising,” “having,” “containing,” “involving,” or variations thereof, is intended to be broad and encompass the subject matter listed thereafter, equivalents, and additional subject matter not recited, i.e., to be open-ended and meaning including but not limited to.

It is to be understood that terms such as “top,” “bottom,” “left,” “right,” “front,” “rear,” or the like may refer to an arbitrary frame of reference, rather than to the ordinary gravitational frame of reference. Likewise, spatially relative terms, such as “inner”, “adjacent”, “outer,” “beneath,” “below,” “lower,” “above,” “upper,” or the like, may be used herein for ease of description to describe one element or feature's relationship to another element(s) or feature(s) as illustrated in the figures. Spatially relative terms may be intended to encompass different orientations of the article in use or operation in addition to the orientation depicted in the figures. For example, if the article in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Terms such as first, second, third, etc. may be used herein to describe various elements, components, regions, layers and/or sections, in which it is understood that these elements, components, regions, layers and/or sections should not be limited by these terms unless stated otherwise. In addition, terms such as “first,” “second,” and other numerical terms when used herein do not imply a sequence or order unless clearly indicated by the context. Thus, a first element, component, region, layer or section discussed herein could be termed a second element, component, region, layer or section without departing from the teachings of this disclosure.

It is to be understood that all values, ranges, ratios or the like as described in this disclosure may be combined in any manner. In addition, it is to be understood that a concentration or amount or value range listed in this disclosure is intended to include any and every concentration or amount or value within the range, including the end points, as if each value within the range has been expressly stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor(s) appreciate and understand that any and all data points within the range are to be considered to have been specified, and that inventor(s) had possession of the entire range and all points within the range.

In addition, each numerical value used in this disclosure should be read once as modified by the term “about” (unless already expressly so modified), and then read again as not so modified unless otherwise indicated in context. The term “about” as used herein refers to any value which lies within the range defined by a variation of up to ±10% of the stated value, for example, ±10%, ±9%, ±8%, ±7%, ±6%, ±5%, ±4%, ±3%, ±2%, ±1%, ±0.01%, or ±0.0% of the stated value, as well as values intervening such stated values. When the term “about” is used in describing a value or an end-point of a range, the disclosure should be understood to include the specific value or end-point referred to.

The term “consisting essentially of” in relation to a composition is to indicate that substantially (e.g., greater than 95 weight % or greater than 99 weight %) of the component(s) present in the composition is the component(s) recited. Therefore, this term does not exclude the presence of minor additives or impurities as would be understood by those having ordinary skill in the art.

Although the invention has been shown and described with respect to a certain embodiment or embodiments, it is apparent that equivalent alterations and modifications will occur to those having ordinary skill in the art upon the reading and understanding this disclosure, and such modifications are intended to be included within the scope of this disclosure as defined in the claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure.

1. A laminate airbag cover, comprising:
a foam layer, and
a single cover layer overlying and operably bonded to the foam layer,
wherein the cover layer is a compact monolayer structure formed from a polyolefin composition comprising, in weight percent based on total weight of the composition:
(a) one or more random copolymer polypropylene(s) (rPP) present in a total amount of up to 15 wt. %;
(b) one or more homopolymer polypropylene(s) (hPP) present in a total amount from 5 wt. % to 20 wt. %;
(c) one or more thermoplastic vulcanizate(s) (TPV) present in a total amount from 25 wt. % to 45 wt. %;
(d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 50 wt. %; and
(e)(1) one or more low density polyethylene(s) (LDPE) present in a total amount of up to 25 wt. %, and/or (e)(2) one or more mineral filler(s) present in a total amount of up to 10 wt. %, wherein a combined total of (e)(1) and (e)(2), when both are present, is up to 25 wt. %;
wherein the polyolefin layer is extrudable and/or calenderable and has a Shore A hardness according to ASTM D2240 in a range from 50 to 70.

2. The laminate airbag cover according to claim 1, wherein the laminate airbag cover is an unweakened airbag cover.

3. The laminate airbag cover according to claim 1, wherein the polyolefin composition comprises, in weight percent based on total weight of the composition:
(a) one or more random copolymer polypropylene(s) (rPP) present in a total amount from 5 wt. % to 10 wt. %;
(b) one or more homopolymer polypropylene(s) (hPP) present in a total amount from 10 wt. % to 20 wt. %;
(c) one or more thermoplastic vulcanizate(s) (TPV) present in a total amount from 25 wt. % to 35 wt. %;
(d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 35 wt. %; and
(e)(1) one or more low density polyethylene(s) (LDPE) present in a total amount from 15 wt. % to 25 wt. %.

4. The laminate airbag cover according to claim 1, wherein the polyolefin composition comprises, in weight percent based on total weight of the composition:
(a) one or more random copolymer polypropylene(s) (rPP) present in a total amount up to 15 wt. %;
(b) one or more homopolymer polypropylene(s) (hPP) present in a total amount from 5 wt. % to 20 wt. %;
(c) one or more thermoplastic vulcanizate(s) (TPV) present in a total amount from 25 wt. % to 45 wt. %;
(d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 30 wt. % to 50 wt. %; and
(e)(2) one or more mineral filler(s) present in a total amount of up to 10 wt. %;
wherein the polyolefin layer is calenderable.

5. The laminate airbag cover according to claim 4, wherein the polyolefin composition comprises, in weight percent based on total weight of the composition:
(a) one or more random copolymer polypropylene(s) (rPP) present in a total amount from 5 wt. % to 10 wt. %;
(b) one or more homopolymer polypropylene(s) (hPP) present in a total amount from 10 wt. % to 15 wt. %;
(c) one or more thermoplastic vulcanizate(s) (TPV) present in a total amount from 35 wt. % to 45 wt. %;
(d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 40 wt. % to 50 wt. %; and
(e)(2) one or more mineral filler(s) present in a total amount of up to 5 wt. %;
wherein the polyolefin layer is calenderable.

6. The laminate airbag cover according to claim 1, wherein the polyolefin composition either:
includes the (e)(1) LDPE(s) and does not include the (e)(2) mineral filler(s); or
includes the (e)(2) mineral filler(s) and does not include the (e)(1) LDPE(s).

7. The laminate airbag cover according to claim 1, wherein the polyolefin composition either:
includes the (d)(1) PoE(s) and does not include the (d)(2) OBC(s); or
includes the (d)(2) OBC(s) and does not include the (d)(1) PoE(s).

8. The laminate airbag cover according to claim 1, wherein proportions of components (a), (b), (c), (d)(1) and/or d(2), (e)(1) and/or (e)(2) in combination total at least 95 wt. % of the composition, not inclusive of colorants and/or stabilizers and/or processing aids.

9. The laminate airbag cover according to claim 1, wherein a density of the polyolefin composition is in a range from 0.85 g/cc to 0.95 g/cc.

10. The laminate airbag cover according to claim 1, wherein the TPV(s) include ethylene propylene diene monomer (EPDM) rubber as an elastomer phase and polypropylene (PP) as a thermoplastic phase.

11. The laminate airbag cover according to claim 1, wherein the PoE(s) are not crosslinked; and, wherein the PoE(s) are selected from ethylene-octene copolymers (EOC), ethylene-butene copolymers (EBC), and/or ethylene-hexene copolymers (EHC).

12. The laminate airbag cover according to claim 1, wherein the mineral filler(s) have a particle size in a range from 0.5 μm to 5 μm.

13. The laminate airbag cover according to claim 1,
wherein the foam layer has a density in a range from 40 to 200 kg/m3, and/or
wherein the Shore A hardness of the laminate is in a range from 30 to 70 according to ASTM D2240.

14. A composite, comprising:
a substrate, and
a cover layer overlying the substrate,
wherein the cover layer includes a layer formed from a composition comprising, in weight percent based on total weight of the composition:
(a) one or more random copolymer polypropylene(s) (rPP) present in a total amount of up to 15 wt. %;
(b) one or more homopolymer polypropylene(s) (hPP) present in a total amount from 5 wt. % to 20 wt. %;
(c) one or more thermoplastic vulcanizate(s) (TPV) present in a total amount from 25 wt. % to 45 wt. %;
(d)(1) one or more polyolefin elastomer(s) (PoE) and/or (d)(2) one or more olefin block copolymer(s) (OBC) having elastomeric segments, wherein the one or more PoE(s) and/or the one or more OBC(s) are present in a total amount from 25 wt. % to 50 wt. %; and
optionally, (e)(1) one or more low density polyethylene(s) (LDPE) present in a total amount of up to 25 wt. %, and/or optionally (e)(2) one or more mineral filler(s) present in a total amount of up to 10 wt. %, wherein a combined total of (e)(1) and (e)(2), when both are present, is up to 25 wt. %.

15. (canceled)

16. A polyolefin composition comprising, in weight percent based on total weight of the composition:
(a) one or more polypropylene random copolymer(s) (rPP) in a total amount from 0 wt. % to about 15 wt. %;
(b) one or more polypropylene homopolymer(s) (hPP) present in a total amount from about 5 wt. % to about 40 wt. %;
(c) one or more thermoplastic vulcanizate(s) (TPV) present in a total amount from about 15 wt. % to about 45 wt. %;
(d) in a total amount from about 20 wt. % to about 50 wt. %, (d)(1) one or more polyolefin elastomer(s) (PoE) present, and/or (d)(2) one or more olefin block copolymer(s) (OBC).

17. (canceled)

18. (canceled)

19. The composition according to claim 16, wherein the component (a) is present in a total amount up to 15 wt. %; more particularly in a total amount from 5 wt. % to 10 wt. %.

20. The composition according to claim 16, wherein the component (b) is present in a total amount from 5 wt. % to 20 wt. %, more particularly in a total amount from 10 wt. % to 20 wt. %; more particularly in a total amount from 10 wt. % to 15 wt. %.

21. The composition according to claim 16, wherein the component (c) is present in a total amount from 25 wt. % to 45 wt. %, more particularly in a total amount from 25 wt. % to 35 wt. % or in a total amount from 35 wt. % to 45 wt. %.

22. The composition according to claim 16, wherein the component (d) is present in a total amount from 30 wt. % to 50 wt. %, more particularly in a total amount from 25 wt. % to 35 wt. % or in a total amount from 40 wt. % to 50 wt. %.

23. The composition according to claim 16, wherein either:
the component (e) is (e)(1) and is present in a total amount from 15 wt. % to 25 wt %.; or
the component (e) is (e)(2) and is present in a total amount of up to 10 wt. %; more particularly in a total amount of up to 5 wt. %.

24. (canceled)
